(19) United States
(12) Patent Application Publication
(10) Pub. No.: US 2006/0293181 A1
(43) Pub. Date: Dec. 28, 2006

(54) Thermal recording materials and methods of making and using the same

(76) Inventors: Robert R. Menize, Nashua, NH (US); Eitan C. Zeira, Hollis, NH (US); Peter S. Morello, Stuart, FL (US); Richard Selah, Newtown, PA (US); Trevor Kelley, Maple Glen, PA (US); Laura Ellen Matz, Holliston, MA (US); David DeGulis, Nashua, NH (US)

Correspondence Address: KIRKPATRICK & LOCKHART NICHOLSON GRAHAM LLP, STATE STREET FINANCIAL CENTER, ONE LINCOLN STREET, BOSTON, MA, 02111-2950, US

(21) Appl. No.: 11/454,234

(22) Filed: Jun. 16, 2006

Related U.S. Application Data
(60) Provisional application No. 60/691,033, filed on Jun. 16, 2005.

(51) Int. Cl. B41M 5/24

(52) U.S. Cl. 503/201

(57) ABSTRACT

Disclosed are thermal recording materials including different regions for recording latent and visible images. The thermal recording materials of the present teachings can include a substrate, a base coating containing an electron-accepting compound, and two or more top coatings each containing a different electron-donating compound. Latent images can be formed in exposed regions of the base coating, while visible images can be recorded in different colors in exposed regions of the top coatings. Methods of preparing and using the thermal recording materials also are disclosed.

This application claims the benefit of the filing date of U.S. Provisional Patent Application Ser. No. 60/691,033, filed on Jun. 16, 2005, the entire disclosure of which is incorporated by reference herein for all purposes.

### FIELD

The present teachings relate to thermal recording materials, and more specifically, to thermal recording materials that include printable regions for recording latent and multi-color visible images.

### INTRODUCTION

Thermal or heat-sensitive recording materials are well known in the art. Generally, these materials consist of a support (e.g., paper or film) onto which a light or colorless color-developing layer is formed. The color-developing layer typically includes both a color-forming substance (e.g., a leuco dye) and a developer (e.g., an acidic substance). When the color-developing layer is selectively exposed to heat, for example, by using a thermal print head, the color-forming substance and the developer in the exposed areas react to produce a visible image. These thermal recording materials are widely used in cash register receipts, bar-coded labels, tickets, and so forth. Examples of thermal recording materials are described in U.S. Pat. Nos. 4,370,370, 4,593,298, 4,721,700, 4,839,332, 4,885,271, and 5,260,252.

The thermal recording materials described above typically are coated on wide web coaters in a single color. There have been some attempts at providing multi-color thermal recording materials, see e.g., U.S. Pat. Nos. 4,665,410, 5,644,352 and 5,536,046. For example, two different colors can be layered atop one another whereby application of low heat activates the top layer alone to generate one color, while application of high heat activates both color layers to produce a darker color. This method, however, is cumbersome and requires special printers to impart two levels of heat. U.S. Pat. No. 5,524,934 teaches a multi-color document where different colors are printed in different regions of the document. Each of the color regions have both dye and developer in the same coating thus requiring a thick layer to produce a sufficient color intensity. Because of the thickness of the coating, the multi-color document cannot be printed using standard printing techniques and equipments.

For certain applications such as receipts, tickets, and so forth, it also will be desirable to provide the ability to record latent images on thermal recording materials. The latent images can provide confidential information intended only for authorized personnel. The latent images also can serve as an authenticating feature.

Accordingly, there is a need for thermal recording materials that can be imprinted with both latent and multi-color visible images. The visible images preferably can be recorded in multiple colors, for example, on different areas of the recording material, so that certain information can be highlighted or made more eye-catching. The latent images can be recorded in areas separate from where the visible images are recorded. For example, in a venue ticket, it can be desirous to print a logo in one color (e.g., green), highlight critical information in another color (e.g., red), print a bar code in black for better scanning properties, and include a latent image for authentication purposes.

### SUMMARY

The present teachings provide a recording material that can record latent and visible images in more than one color (i.e., multi-color), while limiting the thickness of the recording material. The present teachings also relate to preparing such a recording material using conventional printing techniques, for example, with the use of a printing press, and printing the various colors and latent images in one step, preferably, at the same heat setting or energy input.

More specifically, the present teachings provide a thermal or heat-sensitive recording material that can be used to print electronically transmitted images and/or data, for example, as utilized in venue tickets, airline boarding passes, labels, coupons, receipts, prescription slips, lottery tickets, gaming tickets, and so forth. Upon imagewise thermal exposure, the thermal recording material can selectively yield both latent and visually readable images. The latent image can include confidential data intended for authorized recipients only. This latent image subsequently can be rendered visually readable by an authorized recipient. The visually readable images can be in two or more colors. For example, the visually readable images can have different colors on different areas of the recording material.

Generally, the thermal recording materials of the present teachings can include a substrate, a base coating, and two or more top coatings, e.g., a first top coating and a second top coating. The base coating can be disposed on the substrate, whereas the first top coating and the second top coating can be disposed on a portion of the base coating. The base coating can include an electron-accepting compound, whereas each of the first top coating and the second top coating can include an electron-donating compound, i.e., a first electron-donating compound and a second electron-donating compound, adapted to react with the electron-accepting compound in the base coating to induce a color change. In most embodiments, one or more portions of the base coating are exposed, i.e., not covered by either the first top coating or the second top coating, and adapted to record a latent image via imagewise thermal exposure.

The electron-accepting compound in the base coating can be substantially colorless before and after thermal exposure. Examples of suitable electron-accepting compounds include, but are not limited to, various phenolic compounds, aromatic carboxylic acids, their salts, and combinations thereof. Before thermal exposure, the electron-accepting compound in the base coating can be dispersed within a binder and/or can be in crystalline form. After thermal exposure, the base coating can melt to form a solid solution that includes the binder and the electron-accepting compound, or crystals of the electron-accepting compound can melt to form an amorphous solid. In some embodiments, the base coating also can include a sensitizer, for example, one or more diphenoxy alkanes, to reduce the melting point of the electron-accepting compound, thereby reducing the required energy input to form the latent image.

When the base coating is exposed to imagewise thermal exposure, a latent image is produced. The latent image generally is invisible to human eyes. For example, the latent image can be invisible under ambient light. Alternatively, the latent image can be invisible when viewed at a substantially right angle, but can be faintly visible when viewed at an oblique angle. In some embodiments, the latent image can be revealed by contact with an electron-donating compound that is identical to or different from the first electron-donating compound and/or the second electron-donating compound in the first top coating and the second top coating. For example, an ink including one or more electron-donating compounds can be used to reveal the latent image. The one or more electron-donating compounds can include an infrared (IR) or near infrared (NIR) absorbing dye. Many IR and NIR absorbing dyes are known in the art and can be used according to the present teachings. Examples of IR and NIR absorbing dyes include, but are not limited to, 3,3-bis(4-diethylamino-2-ethoxyphenyl)-4-azaphthalide, 3-[2,2-bis(1-ethyl-2-methyl-3-indolyl)vinyl]-3-(4-diethylaminophenyl)phtharide, and 3,3-bis[2-(4-dimethylaminophenyl)-2-(4-methoxyphenyl)vinyl]-4,5,6,7-tetrachlorophthalide. The use of such IR or NIR absorbing dyes provides an additional security feature which allows authorized personnel to further verify the authencity of the recording material using an IR or NIR reader. More specifically, a latent image revealed by a non-IR or non-NIR absorbing dye typically will disappear if read under IR or NIR light, while a latent image revealed by an IR or NIR absorbing dye typically will not disappear. In certain embodiments, the base coating is substantially free of electron-donating compounds.

With regard to the first top coating and the second top coating, the first electron-donating compound and the second electron-donating compound can be substantially colorless. Examples of suitable electron-donating compounds to be included in the first top coating and the second top coating include, but are not limited to, thermal dyes such as various triarylmethane-based compounds, auramine-based compounds, thiazine-based compounds, spiropyran-based compounds, lactam-based compounds, fluoran-based compounds, and combinations thereof. The first electron-donating compound can be adapted to induce a color change different than the second electron-donating compound. Each of the first top coating and the second top coating can be substantially free of electron-accepting compounds.

In alternative embodiments, a thermal recording material according to the present teachings can include a substrate, a base coating including an electron-donating compound, and a first top coating and a second top coating each including an electron-accepting compound, which in most other respects is similar to the thermal recording materials described above.

The present teachings also relate to methods of recording latent and multi-color visible images onto a thermal recording material. The methods can include providing a thermal recording material as described above where at least one exposed region of the base coating is present, heating imagewise the exposed region of the base coating to produce a latent image, and heating imagewise the first top coating and the second top coating to produce visible images. In some embodiments, heating imagewise the first top coating can produce a visible image of one color and heating imagewise the second top coating can produce a visible image of a different color.

The steps of heating the base coating, the first top coating, and the second top coating, can be performed separately. However, in preferred embodiments, only one heating step is required to thermally expose all three coatings to produce latent and visible images. One or more of the heating steps can be carried out using a direct thermal printer. In some embodiments, the method can further include the step of contacting the exposed region of the base coating with an electron-donating compound (or electron-accepting compound) to reveal the latent image.

The present teachings further relate to methods of preparing a thermal recording material for recording latent and multi-color visible images. The methods can include applying a base coating onto a substrate, wherein the base coating includes an electron-accepting compound and is adapted to record a latent image via imagewise thermal exposure, followed by application of a first top coating and a second top coating onto different portions of the base coating, wherein each of the first top coating and the second top coating includes an electron-donating compound adapted to react with the electron-accepting compound in the base coating to induce a color change. In some embodiments, the first electron-donating compound can be adapted to induce a color change different than the second electron-donating compound. A latent image recorded on the base coating can be revealed by contact with an electron-donating compound.

Various methods can be used to apply the different coatings onto the substrate to prepare the thermal recording material. For example, the base coating can be applied to the substrate using a wide web coater. In some embodiments, the first top coating and/or the second top coating can be applied to a portion of the base coating using a printing press. It should be understood that the methods also include using and making the alternative embodiments of the thermal recording materials described herein.

The foregoing, and other features and advantages of the present teachings will become apparent through reference to the following description, the accompanying drawings, and the claims. Furthermore, it is to be understood that the features of the various embodiments described herein are not mutually exclusive and can exist in various combinations and permutations.

### BRIEF DESCRIPTION OF THE DRAWING

In the drawings, like reference characters generally refer to the same parts throughout the different views. Also, the drawings are not necessarily to scale, emphasis generally being placed upon illustrating the principles of the present teachings.

FIG. 1 is a perspective view of an embodiment of a recording material according to the present teachings.

FIG. 2 is a schematic cross-sectional view of an embodiment of a recording material according to the present teachings.

### DETAILED DESCRIPTION

Throughout the description, where compositions are described as having, including, or comprising specific components, or where processes are described as having, including, or comprising specific process steps, it is contemplated that compositions of the present teachings also consist essentially of, or consist of, the recited components, and that the processes of the present teachings also consist essentially of, or consist of, the recited processing steps. It should be understood that the order of steps or order for performing certain actions is immaterial so long as the method remains operable. Moreover, two or more steps or actions can be conducted simultaneously.

In the application, where an element or component is said to be included in and/or selected from a list of recited elements or components, it should be understood that the element or component can be any one of the recited elements or components and can be selected from a group consisting of two or more of the recited elements or components.

The use of the singular herein includes the plural (and vice versa) unless specifically stated otherwise. In addition, where the use of the term “about” is before a quantitative value, the present teachings also include the specific quantitative value itself, unless specifically stated otherwise.

It is to be understood that any percentages provided herein are percentages based on the total dry weight of the coating, unless otherwise indicated.

A thermal recording material according to the present teachings can include at least one printable region for recording latent, i.e., invisible, images and two or more printable regions for recording visible images. Structurally, the thermal recording material includes a substrate, a base coating, and two or more top coatings. A substrate, such as paper, a synthetic resin film, or the like, can be coated on one surface with the base coating. Subsequently, two or more top coatings can be deposited on discrete regions of the base coating. For example, a first top coating can be disposed on a first region of the base coating, while a second top coating can be disposed on a second region of the base coating that is contiguous or non-contiguous to the first region. One or more regions of the base coating can be exposed, i.e., not covered by the first top coating or the second top coating, onto which latent images can be recorded. Visible images can be recorded in exposed regions of the first top coating and the second top coating, preferably in more than one color. For example, a visible image recorded in an exposed region of the first top coating can be produced in a color different than a visible image recorded in an exposed region of the second top coating.

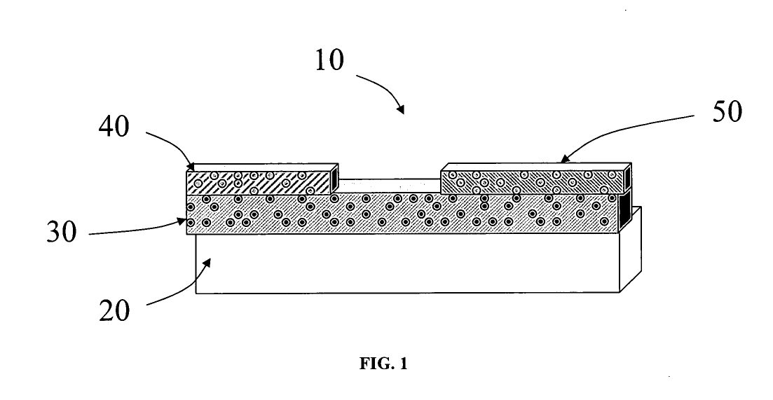

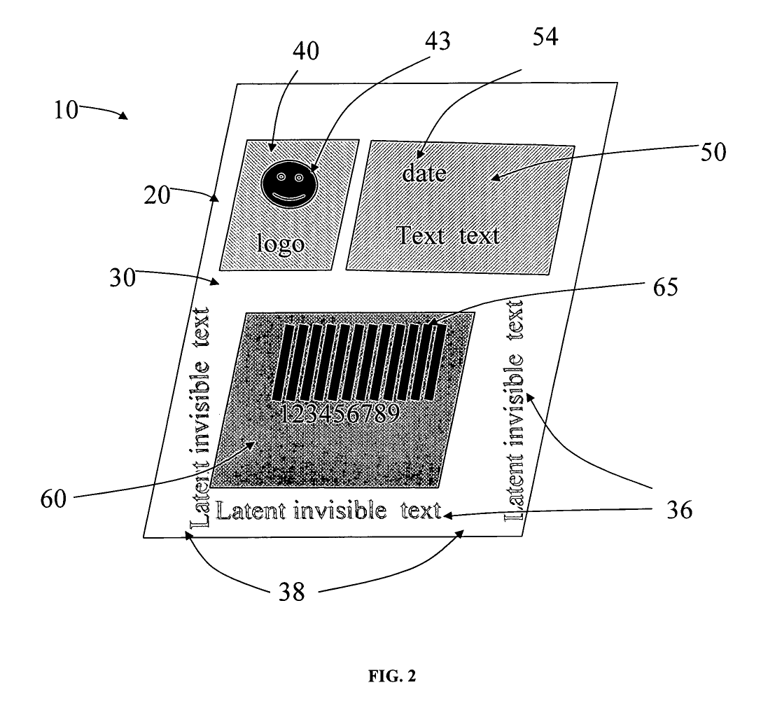

FIGS. 1 and 2 schematically illustrate a thermal recording material according to the present teachings. Referring to FIG. 1, a thermal recording material 10 includes a web or substrate 20, a base coating 30, a first top coating 40, and a second top coating 50. The base coating can be applied to one surface of the substrate, and can fully cover the substrate. The base coating can include virtually any type of thermal coating known in the art, and preferably contains one or more electron-accepting compounds (e.g., acidic compounds), dispersed within a binder together with other possible additives including stabilizers, whitening agents, dispersants, fillers (pigments), sensitizers, and lubricants. The base coating differs from a standard thermal coating in that it typically is substantially free of any electron-donating compounds, e.g., a leuco dye. As a result, the base coating is substantially colorless before and after thermal exposure.

The electron-accepting compounds, also known in the art as developers or reactants, initially can be present in the base coating in crystalline form. When the electron-accepting compound is in crystalline form, it generally will not react, or will react only inefficiently, with an electron-donating compound. Once heated, crystals of the electron-accepting compound melt to form an amorphous solid which can be reacted with an electron-donating compound, e.g., a dye, to form a visually readable image. Thus, upon imagewise thermal exposure, for example, during the printing process in a direct thermal printer, a latent image can be formed, which subsequently can be revealed to an authorized recipient by contacting the latent image with an electron-donating compound.

Many electron-accepting (acidic) compounds which function as a developer in the color-developing layer of thermal recording materials known in the art can be used in forming the base coating. Examples of such compounds include what is sometimes referred to in the art as the “B mix” component of the color-developing layer, as well as those disclosed in U.S. Pat. Nos. 4,721,700 and 4,885,271. Generally, such electron-accepting compounds include organic electron acceptors such as phenolic compounds, aliphatic and aromatic carboxylic acids, and their polyvalent metal salts. These materials are characterized by their ability to induce a color change in a leuco dye.

Examples of suitable electron-accepting compounds include, but are not limited to, tert-butylphenol, α-naphthol, β-naphthol, 4-acetylphenol, 4-tert-octylphenol, 4,4′-sec-butylidenediphenol, 4-phenylphenol, 4,4′-dihydroxy-diphenylmethane 4,4′-isopropylidenediphenol, hydroquinone, 4,4′-cyclohexylidenediphenol, 4,4′-dihydroxydiphenylsulfide, 4,4′-thiobis(6-tert-butyl-3-methylphenol), 4,4′-dihydroxydiphenylsulfone, hydroquinone monobenzyl ether, 4-hydroxybenzophenone, 2,4-dihydroxybenzophenone, 2,4,4′-trihydroxybenzophenone, 2,2′,4,4′-tetrahydroxybenzophenone, dimethyl 4-hydroxyphthalate, methyl 4-hydroxybenzoate, ethyl 4-hydroxybenzoate, propyl 4-hydroxybenzoate, sec-butyl 4-hydroxybenzoate, pentyl 4-hydroxybenzoate, phenyl 4-hydroxybenzoate, benzyl 4-hydroxybenzoate, tolyl 4-hydroxybenzoate, chlorophenyl 4-hydroxybenzoate, phenylpropyl 4-hydroxybenzoate, phenethyl 4-hydroxybenzoate, p-chlorobenzyl 4-hydroxybenzoate, p-methoxybenzyl 4-hydroxybenzoate, novolak phenol resin, phenolic polymers and other like phenolic compounds; benzoic acid, p-tert-butylbenzoic acid, trichlorobenzoic acid, terephthalic acid, 3-sec-butyl-4-hydroxybenzoic acid, 3-cyclohexyl-4-hydroxybenzoic acid, 3,5-dimethyl-4-hydroxybenzoic acid, salicylic acid, 3-isopropylsalicylic acid, 3-tert-butylsalicylic acid, 3-benzylsalicylic acid, 3-(α-methylbenzyl)salicylic acid, 3-chloro-5-(α-methylbenzyl)salicylic acid, 3,5-di-tert-butylsalicylic acid, 3-phenyl-5-(α,α-dimethylbenzyl)salicylic acid, 3,5-di-α-methylbenzylsalicylic acid and like aromatic carboxylic acids, and also salts of such phenolic compounds and aromatic carboxylic acids with zinc, magnesium, aluminum, calcium, titanium, manganese, tin, nickel and like polyvalent metals.

Specific examples of preferred electron-accepting compounds which can be used according to the present teachings include 4-hydroxy-4′ isopropoxy diphenyl sulfone, bisphenol A, bisphenol S, and benzyl p-hydroxybenzoate.

Referring to FIG. 2, the recording material 10 includes latent image-generating regions in which latent images 36 are recorded. These latent images 36 are virtually visually indistinguishable from background areas 38. The latent images 36 can be invisible to human eyes when viewed under ambient light or at a substantially right angle. These images can be slightly discernable when viewed in particular wavelengths of light or in very bright light, or when the recording material is viewed carefully from an oblique angle.

The latent image-generating property of the thermal recording materials of the present teachings is useful for conveying confidential information and for authentication purposes. The information transmitted onto the thermal recording material can include alphanumeric or graphic information, and can serve as an authentication means. This information or data can be transmitted electronically, via digital or analog transmission means, and generally must be heat-transferred onto the material of the present teachings. As described above, the latent images can be easily converted to a readable format upon application (preferably by an authorized recipient) of an electron-donating compound. For example, the electron-donating compound can be formulated as an ink used in a felt tip pen. Using such a felt tip pen, the authorized recipient can write across the latent image portion to reveal the latent image.

As an added security feature, the electron-donating compound can be an infrared (IR) or near infrared (NIR) absorbing dye. The use of such IR or NIR absorbing dye can allow an authorized recipient or authorized personnel to further verify the authencity of the recording material with the use of an IR or NIR reader. More specifically, a latent image revealed by a non-IR or non-NIR absorbing dye typically will disappear if read under IR or NIR light, while a latent image revealed by an IR or absorbing NIR dye typically will not disappear. Examples of IR and NIR absorbing dyes include, but are not limited to, 3,3-bis(4-diethylamino-2-ethoxyphenyl)-4-azaphthalide, 3-[2,2-bis(1-ethyl-2-methyl-3-indolyl)vinyl]-3-(4-diethylaminophenyl)phtharide, and 3,3-bis[2-(4-dimethylaminophenyl)-2-(4-methoxyphenyl)vinyl]-4,5,6,7-tetrachlorophthalide. Other IR and NIR absorbing dyes known in the art also can be used according to the present teachings.

While it is preferred to coat the thermal recording material in the latent image-generating region of the recording material with a binder and an electron-accepting compound, it is also possible to provide, alternatively, a binder and an electron-donating compound, i.e., what is sometimes referred to in the art as the “A mix” component of a color-developing layer. In such a case, the latent image can be made readable through subsequent application of an electron-accepting compound (i.e., a developer) to the latent image-generating region.

Two or more top coatings can be applied, e.g., by spot printing, onto specific areas of the base coating where visible imaging is desired. With reference to FIG. 2, a first top coating 40 and a second top coating 50 are coated on discrete areas of base coating 30 to provide separate regions for recording visible images. In the specific embodiment illustrated in FIG. 2, a third top coating 60 also is present to provide a third printable region. Each of the top coatings 40, 50, and 60 can include an electron-donating compound dispersed within a binder together with various additives similar to those identified above in connection with the base coating 30. In preferred embodiments, the electron-donating compounds in each of the top coatings 40, 50, and 60 can be different and can be capable of inducing a unique color change, such that when the corresponding printable regions are activated by heat, images of different colors are formed.

As shown in FIG. 2, some regions of the base coating are left exposed, i.e., not covered by one of the top coatings 40, 50, and 60, and can be used for recording a latent image, e.g., latent text 54. Recorded in exposed regions of top coatings 40, 50, and 60 are a logo 43, visible text 54, and a bar code 65, respectively. By using different electron-donating compounds in top coatings 40, 50, and 60, one can provide the logo 43 in one color, the visible text 54 in another color, and the bar code 65 in a third color. Thus, according to the present teachings, different coatings comprising different leuco dyes can be deposited in different areas of the recording material to impart different color capabilities to different regions of the recording material.

Each of the top coatings can be a typical color-developing layer, i.e., a coating that includes both an electron-donating compound (i.e., a color former) and an electron-accepting compound (i.e., a developer). In certain embodiments, however, each of the top coatings is substantially free of any electron-accepting compounds, and is adapted to react with the electron-accepting compounds in the base coating to produce a visible image. By including only electron-donating materials in the top coatings, the thickness of the recording material can be reduced as a whole, which enables the recording material to be printed with standard printing equipment, e.g., on a printing press. The electron-donating compounds selected for each of the top coatings will determine the color of the image formed upon imagewise thermal exposure, while its reaction with the electron-accepting compound in the base coating will develop the image in that color. Alternatively, the top coatings can be made to partially overlap to produce various shades and hues of the two conjoining coatings.

The electron-donating compounds for use according to the present teachings, such as those used in the top coatings, can be of the type generally known in the art. Typically, these are pale or colorless compounds which can be activated alone or in combination with other such materials following contact with an electron-accepting compound. Such electron-donating compounds can include all of the leuco dyes commonly used for thermal recording materials, including triphenylmethane-based compounds, auramine-based compounds, thiazine-based compounds, spiropyran-based compounds, lactam-based compounds, and fluoran-based compounds. Generic and specific examples of such electron-donating materials are disclosed in U.S. Pat. Nos. 4,370,370, 4,593,298, and 4,839,332.

Exemplary triarylmethane-based compounds include, but are not limited to, 3,3-bis(p-dimethylaminophenyl)-6-dimethylaminophthalide, 3,3-bis(p-dimethylaminophenyl)phthalide, 3-(p-dimethylaminophenyl)-3-(1,2-dimethylindole-3-yl)phthalide, 3-(p-dimethylaminophenyl)-3-(2-methylindole-3-yl)phthalide, 3,3-bis(1,2-dimethylindole-3-yl)-5-dimethylaminophthalide, 3,3-bis(1,2-dimethylindole-3-yl)-6-dimethylaminophthalide, 3,3-bis(9-ethylcarbazole-3-yl)-6-dimethylaminophthalide, 3,3-bis(2-phenylindole-3-yl)-6-dimethylaminophthalide, and 3-p-dimethylaminophenyl-3-(1-methylpyrrole-3-yl)-6-dimethylaminophthalide.

Examples of auramine-based compounds include, but are not limited to, 4,4′-bis-dimethylaminobenzhydryl benzyl ether, N-halophenyl-leucoauramine, and N-2,4,5-trichlorophenyl-leucoauramine.

Examples of thiazine-based compounds include, but are not limited to, benzoyl-leucomethyleneblue, and p-nitrobenzoyl-leucomethyleneblue.

Spiropyran-based compounds include, but are not limited to, 3-methyl-spiro-dinaphthopyran, 3-ethyl-spiro-dinaphthopyran, 3-phenyl-spiro-dinaphthopyran, 3-benzyl-spiro-dinaphthopyran, 3-methyl-naphtho-(6′-methoxybenzo)spiropyran, and 3-propyl-spiro-dibenzopyran.

Lactam-based compounds include, but are not limited to, rhodamine-B-anilinolactam, rhodamine-(p-nitroanilino)lactam, and rhodamine-(o-chloroanilino)lactam.

Fluoran-based compounds include, but are not limited to, 3-dimethylamino-7-methoxyfluoran, 3-diethylamino-6-methoxyfluoran, 3-diethylamino-7-methoxyfluoran, 3-diethylamino-7-chlorofluoran, 3-diethylamino-6-methyl-7-chlorofluoran, 3-diethylamino-6,7-dimethylfluoran, 3-(N-ethyl-p-toluidino)-7-methylfluoran, 3-diethylamino-7-(N-acetyl-N-methylamino)fluoran, 3-diethylamino-7-N-methylaminofluoran, 3-diethylamino-7-dibenzylaminofluoran, 3-diethylamino-7-(N-methyl-N-benzylamino)fluoran, 3-diethylamino-7-(N-chloroethyl-N-methylamino)fluoran, 3-diethylamino-7-N-diethylaminofluoran, 3-(N-ethyl-p-toluidino)-6-methyl-7-phenylaminofluoran, 3-(N-ethyl-p-toluidino)-6-methyl-7-(p-toluidino)fluoran, 3-diethylamino-6-methyl-7-phenylaminofluoran, 3-dibutylamino-6-methyl-7-phenylaminofluoran, 3-diethylamino-7-(2-carbomethoxyphenylamino)fluoran, 3-(N-cyclohexyl-N-methylamino)-6-methyl-7-phenylaminofluoran, 3-pyrrolidino-6-methyl-7-phenylaminofluoran, 3-piperidino-6-methyl-7-phenylaminofluoran, 3-diethylamino-6-methyl-7-xylidinofluoran, 3-diethylamino-7-(o-chlorophenylamino)fluoran, 3-dibutylamino-7-(o-chlorophenylamino)fluoran, 3-pyrrolidino-6-methyl-7-p-butylphenylaminofluoran, 3-(N-methyl-N-n-amylamino)-6-methyl-7-phenylaminofluoran, 3-(N-ethyl-N-n-amylamino)-6-methyl-7-phenylaminofluoran, 3-(N-ethyl-N-isoamylamino)-6-methyl-7-phenylaminofluoran, 3-(N-methyl-N-n-hexylamino)-6-methyl-7-phenylaminofluoran, 3-(N-ethyl-N-n-hexylamino)-6-methyl-7-phenylaminofluoran, and 3-(N-ethyl-N-β-ethylhexylamino)-6-methyl-7-phenylaminofluoran.

Preferred electron-donating compounds, which can be used alone or in combination, include the following: 3-isopentyl ethyl amino-6-methyl-7-anilino fluoran, 3-isobutyl ethyl amino-6-methyl-7-anilino fluoran, 3-diethylamino-6-methyl-7-anilino fluoran, 3-N-ethyl-N-tetrahydrofurfurylamino-6-methyl-7-anilino fluoran, and crystal violet lactone.

The electron-donating compounds identified above for use in the top coatings, as well as other such compounds well known in the art, can be used separately to render latent images recorded in the base coating visually readable. Similarly, the IR and NIR absorbing dyes identified above for use in revealing the latent images, as well as other such compounds well known in the art, can be included in one or more of the top coatings to provide additional security features. It should be understood that each of the top coatings and an ink used to reveal the latent image can include more than one type of electron-donating compounds.

The polymeric binder to be used with any of the coatings described above can include one or a mixture of resinous materials. The binder helps to hold the various components of the coating together, as well as to bind them to the layer underneath (i.e., the base coating or the substrate). The binder typically comprises about 2 to 15 percent of the composition of the base coating and about 3 to 8 percent of the total coating composition. Examples of useful binders include, but are not limited to, polyvinyl alcohol, polyvinyl pyrrolidone, polyacrylamide, starches, hydroxyethyl cellulose, methyl cellulose, carboxymethyl cellulose, gelatin, casein, and gum arabic. Latex emulsions such as acrylics, styrene-butadiene copolymers, styrene-maleic anhydride copolymers, ethylene-acrylic acid copolymers, acrylonitrile-butadiene copolymers, vinyl acetate emulsions, ethylene-vinyl acetate emulsions, and polyurethanes can be used as well. Preferred binder material includes low-viscosity polyvinyl alcohols, such as AIRVOL™ 107, 125, 165, 203, 205, 325, 350, 425, 523, 540, 704, 714, and 736, all of which are available from Air Products and Chemicals, Inc., Allentown, Pa. Other types of polyvinyl alcohol can be used, including ELVANOL™ 75-15 available from DuPont. Polyvinyl alcohol binders used with the recording materials of the present teachings can be partly or fully hydrolyzed.

The same binder material need not necessarily be used in the two types of coatings. In certain embodiments, a base coating includes a fully hydrolyzed polyvinyl alcohol while the top coatings include a partly hydrolyzed (e.g., about 80%) polyvinyl alcohol. Both layers typically include various inert processing and property-improving materials as mentioned above, including neutralizing agents, fillers (pigments), lubricants, dispersants, and defoaming agents, all of which are present in relatively minor amounts.

Fillers (pigments) include alumina trihydrate, calcium carbonate, calcined clay, silicon dioxide, talc, and clay. Other filler materials well known in the art can be included as well. These materials can be present alone or in combination with each other. Typically, these materials are present as dispersed particles having a diameter of about 1 micron. Fillers typically are present in the coating at about 25 to 65 percent, depending upon the filler composition.

Both layers can include an antioxidant or stabilizing material of the type commonly used in the manufacture of thermal recording materials to preserve both latent and developed images. With regard to the base coating, a latent image can be lost in some instances as the electron-accepting compounds recrystallize from their amorphous form. The use of stabilizers can prevent or at least retard recrystallization of the electron-accepting compounds, thus providing greater longevity to the latent image. One skilled in the art will readily appreciate that the longevity of the latent image can be controlled by the choice of stabilizers. An example of a stabilizer is 1,1,3-tris(2-methyl-4-hydroxy-5-t-butylphenyl)butane. Such a material is available under the trade name “AO-30” from Nagase America Corporation, New York, N.Y. In certain embodiments, AO-30 comprises approximately 1.5 to 6.5 percent of the total composition. The need for antioxidants, as is well known in the art, is dependent upon the choice of the developer.

The dispersants and lubricants which can be used with the recording materials of the present teachings are well known in the art and are widely used in the manufacture of thermal paper. Exemplary dispersants include polyacrylate compounds, polyvinylpyrrolidone and the ammonium salt of styrene acrylic acid copolymer. Exemplary lubricants include zinc stearate, amine wax, paraffin wax and carnuba wax.

Sensitizing compounds commonly are used in association with thermal coatings to lower their melting point to reduce the required energy input. Many of such sensitizing compounds are known in the art and can be used with both the base coating and the top coatings of the present teachings. Examples of sensitizers include various diphenoxy alkanes, such as 1,2-diphenoxyethane, 1-(2-methylphenoxy)-2-phenoxyethane, 1-(3-methylphenoxy)-2-phenoxyethane, 1-(4-methylphenoxy)-2-phenoxyethane, 1-(2,3-dimethylphenoxy)-2-phenoxyethane, 1-(2,4-dimethylphenoxy)-2-phenoxyethane, 1-(3,4-dimethylphenoxy)-2-phenoxyethane, 1-(3,5-dimethylphenoxy)-2-phenoxyethane, 1-(4-ethylphenoxy)-2-phenoxyethane, 1-(4-isopropylphenoxy)-2-phenoxyethane, 1-(4-tert-butylphenoxy)-2-phenoxyethane, 1,2-di(2-methylphenoxy)ethane, 1-(4-methylphenoxy)-2-(2-methylphenoxy)ethane, 1-(3,4-dimethylphenoxy)-2-(2-methylphenoxy)ethane, 1-(4-ethylphenoxy)-2-(2-methylphenoxy)ethane, 1-(4-isopropylphenoxy)-2-(2-methylphenoxy)ethane, 1-(4-tert-butylphenoxy)-2-(2-methylphenoxy)ethane, 1,2-di(3-methylphenoxy)ethane, 1-(4-methylphenoxy)-2-(3-methylphenoxy)ethane, 1-(2,3-dimethylphenoxy)-2-(3-methylphenoxy)ethane, 1-(2,4-dimethylphenoxy)-2-(3-methylphenoxy)ethane, 1-(3,4-dimethylphenoxy)-2-(3-methylphenoxy)ethane, 1-(4-ethylphenoxy)-2-(3-methylphenoxy)ethane, 1-(4-isopropylphenoxy)-2-(3-methylphenoxy)ethane, 1-(4-tert-butylphenoxy)-2-(3-methylphenoxy)ethane, 1,2-di(4-methylphenoxy)ethane, 1-(2,3-dimethylphenoxy)-2-(4-methylphenoxy)ethane, 1-(2,4-dimethylphenoxy)-2-(4-methylphenoxy)ethane, 1-(2,5-dimethylphenoxy)-2-(4-methylphenoxy)ethane, 1-(3,4-dimethylphenoxy)-2-(4-methylphenoxy)ethane, 1-(4-ethylphenoxy)-2-(4-methylphenoxy)ethane, 1-(4-isopropylphenoxy)-2-(4-methylphenoxy)ethane, 1-(4-tert-butylphenoxy)-2-(4-methylphenoxy)ethane, 1,2-di(2,3-dimethylphenoxy)ethane, 1-(2,5-dimethylphenoxy)-2-(2,3-dimethylphenoxy)ethane, 1,2-di(2,4-dimethylphenoxy)ethane, 1-(4-ethylphenoxy)-2-(2,4-dimethylphenoxy)ethane, 1-(4-tert-butylphenoxy)-2-(2,4-dimethylphenoxy)ethane, 1,2-di(2,5-dimethylphenoxy)ethane, 1-(3,4 dimethylphenoxy)-2-(2,5-dimethylphenoxy)ethane, 1-(4-ethylphenoxy)-2-(2,5-dimethylphenoxy)ethane, 1-(4-tert-butylphenoxy)-2-(2,5-dimethylphenoxy)ethane, 1,2-di(3,4-methylphenoxy)ethane, 1,2-di(3,5-dimethylphenoxy)ethane, 1,2-di(4-ethylphenoxy)ethane, 1,3-di(4-methylphenoxy)propane, 1-(4-methylphenoxy)-2-naphthoxy(1)-ethane, 1-(2,5-dimethylphenoxy)-2-naphthoxy(1)-ethane, 1,2-dinaphthoxy(1)-ethane, 1-(2-chlorophenoxy)-2-phenoxyethane, 1-(2-chlorophenoxy)-2-(2-methylphenoxy)ethane, 1-(2-chlorophenoxy)-2-(3-methylphenoxy)ethane, 1-(2-chlorophenoxy)-2-(4-methylphenoxy)ethane, 1-(4-chlorophenoxy)-2-phenoxyethane, 1-(4-chlorophenoxy)-2-(2-methylphenoxy)ethane, 1-(4-chlorophenoxy)-2-(3-methylphenoxy)ethane, 1-(4-chlorophenoxy)-2-(4-methylphenoxy)ethane, 1-(4-acetylphenoxy)-2-phenoxyethane, 1-(4-acetylphenoxy)-2-(2-metylphenoxy)ethane, 1-(4-propionylphenoxy)-2-phenoxyethane, 1-(2-methoxyphenoxy)-2-(4-methylphenoxy)ethane, 1-(3-methoxyphenoxy)-2-(4-methylphenoxy)ethane, 1,2-di(4-methoxyphenoxy)ethane, 1-(4-methoxyphenoxy)-2-phenoxyethane, 1-(4-methoxyphenoxy)-2-(2-methylphenoxy)ethane, 1-(4-methoxyphenoxy)-2-(3-methylphenoxy)ethane, 1-(4-methoxyphenoxy)-2-(4-methylphenoxy)ethane, 1-(4-methylthiophenoxy)-2-phenoxyethane, 1-(4-methoxycarbonylphenoxy)-2-phenoxyethane, 1-(4-cyanophenoxy)-2-phenoxyethane, 1-(4-cyanophenoxy)-2-(2-methylphenoxy)ethane, 1-(4-cyanophenoxy)-2-(3-methylphenoxy)ethane, 1-(4-cyanophenoxy)-2-(4-methylphenoxy)ethane, 1-(4-nitrophenoxy)-2-phenoxyethane, 1-(4-nitrophenoxy)-2-(4-methylphenoxy)ethane, 1-(4-cyclohexenylphenoxy)-2-phenoxyethane, 1-(4-chlorophenoxy)-2-(4-tert-butylphenoxy)ethane, 1-(4-methoxyphenoxy)-2-(4-tert-butylphenoxy)ethane, 1-(4-acetylphenoxy)-2-(4-tert-butylphenoxy)ethane, 1-(4-methylthiophenoxy)-2-(4-tert-butylphenoxy)ethane, 1-(4-acetylphenoxy)-4-phenoxybutane, 1-(4-methoxyphenoxy)-4-phenoxybutane, 1-(4-methylthiophenoxy)-4-phenoxybutane, and 1-(4-cyanophenoxy)-4-phenoxybutane.

Sensitizers include parabenzyl biphenyl, dimethyl benzyl oxalate, M-terphenyl, diphenoxyethane, benzyl ester of p-nitro benzoic acid (e.g., Nipafax BPN™, available from Nipa Laboratories, Ltd., of Glamorgan, U.K.), 2-benzyloxy-naphthalene, dibenzyl terephthalate, dibenzyl oxalate, and diphenyl carbonate. These sensitizers are generally used in weight percentages in the range of 2.0 to 25.0 and most preferably in the range of 4 to 10.

Thermal recording materials of the present teachings can be prepared by coating a substrate or document (e.g., paper) sequentially with the base coating, then with the top coatings. The general methods of applying coatings to a paper substrate to produce a thermal recording material, which are well known in the art, can be applied to the present teachings. The base coating can be coated on the substrate using general coating techniques, such as bar coating, blade coating, air knife coating, gravure coating, roll coating, spray coating, dip coating, and the like, followed by drying. In certain embodiments, the base coating can be applied to the substrate using a wide web coater. After the base coating is dried, the top coatings, which can contain different color dyes, can be selectively applied onto portions of the base coating. For example, the first top coating and the second top coating can be spot-printed onto the base coating using a printing press.

The total coating weight is well known in the art, and can be in the range of from about 1 to 10 grams per square meter. In certain embodiments, the coating weight is about 4 to 6 grams per square meter.

Various means for applying the electron-donating compound to the latent image are disclosed in U.S. Pat. No. 5,260,252. For example, other than the felt tip pen embodiment described above, the electron-donating compound can be mixed with other materials and shaped into a wax stick or a wiper-type applicator. The wax stick or the wiper-type applicator can be hand-held and selectively drawn across the latent image portion to reveal the latent image.

Latent and visible images can be recorded onto a thermal recording material of the present teachings in multiple steps. For example, after the base coating is applied to the substrate, the base coating can be thermally treated to record latent images, before any of the top coatings is applied thereon. In certain embodiments, the latent and visible images are recorded onto exposed regions of the base coating, the first top coating, and the second top coating simultaneously, i.e., in one step. For example, exposed regions of all three coatings can be imagewise thermally exposed in one step using a direct thermal printer.

The following examples illustrate various coating formulations which can be used to prepare the thermal recording materials of the present teachings.

### EXAMPLES

### Example 1

An exemplary base coating, i.e., the latent image-generating layer, can be prepared with one of the formulations shown below and identified as Mixes B-1, B-2, B-3, B-4, B-5, and B-6. The components of each formula for Mixes B-1, B-2, B-3, B-4, B-5, and B-6 can be mixed and ground in an attritor for 30 minutes. The attrited mixture is then coated on paper and dried to give a coating weight of 6 grams per square meter.

| | | Parts by | |
|---|---|---|---|
| | Formula Components | weight (wet) | Function |
| Mix B-1 | Polyvinyl alcohol | 100 | Binder |
| | (approximately 10% solution) | | |
| | P-benzyl hydroxybenzoate | 20.0 | Developer |
| | Aluminum trihydrate | 27.5 | Filler |
| | Calcium carbonate | 2.5 | Filler |
| | Acrylic polyelectrolyte | 2.0 | Dispersant |
| | (DARVAN ™ No. 7) | | |
| | Zinc Stearate | 10.0 | Lubricant |
| | Water | 140 | |
| Mix B-2 | Polyvinyl alcohol | 100 | Binder |
| | (approximately 10% solution) | | |
| | Bis-phenol A | 20.0 | Developer |
| | Talc | 28.0 | Filler |
| | Calcium carbonate | 3.0 | Filler |
| | (particulate) | | |
| | Acrylic polyelectrolyte | 2.0 | Dispersant |
| | (DARVAN ™ No. 7) | | |
| | Stearic acid amide | 10.0 | Lubricant |
| | Water | 140 | |
| Mix B-3 | Polyvinyl alcohol | 7.1 | Binder |
| | Benzyl hydroxybenzoate | 23.2 | Developer |
| | Dibenzyl terephthalate | 4.1 | Sensitizer |
| | Zinc Stearate | 6.4 | Lubricant |
| | AO-30 | 4.1 | Stabilizer |
| | DARVAN ™ | 0.5 | Dispersant |
| | Calcium carbonate | 46.0 | Whitening |
| | | | agent/filler |
| | Calcined clay | 8.6 | Filler |
| Mix B-4 | Polyvinyl alcohol | 7.5 | Binder |
| | Benzyl hydroxybenzoate | 21.6 | Developer |
| | Dibenzyl terephthalate | 4.7 | Sensitizer |
| | Zinc Stearate | 7.5 | Lubricant |
| | AO-30 | 4.7 | Stabilizer |
| | DARVAN ™ NO. 7 | 0.6 | Dispersant |
| | Magnesium silicate | 53.4 | Filler |
| Mix B-5 | Polyvinyl alcohol | 7.2 | Binder |
| | Bisphenol A | 26.5 | Developer |
| | Dibenzyl oxalate | 13.2 | Sensitizer |
| | DARVAN ™ NO. 7 | 0.2 | Dispersant |
| | Alumina trihydrate | 52.9 | Filler |
| Mix B-6 | Polyvinyl alcohol | 8.3 | Binder |
| | 4-hydroxy-4′ isopropoxy | 20.9 | Developer |
| | diphenyl sulfone | | |
| | Kem W40 | 12.5 | Amide wax |
| | Zinc Stearate | 12.5 | Lubricant |
| | Diphenyl carbonate | 14.3 | Sensitizer |
| | Lupasol 208 | 0.3 | Dispersant |
| | Calcium carbonate | 18.7 | Filler |
| | Calcined clay | 11.3 | Filler |
| | Carboxy methyl cellulose | 1.2 | Binder |

Lupasol 208 is an ammonium salt of a styrene acrylic acid copolymer, available from BASF.

### Example 2

An exemplary top coating, i.e., the visible image-forming layer, can be made by preparing one of the following dispersions shown below. Each of the Mixes A-1 through A-3 can be prepared by first dispersing the ingredients in water using a Baranco mixer for 15 minutes, and then reducing the particle size by way of attrition for 60 minutes.

| | | Parts by weight | |
|---|---|---|---|
| | Formula Components | weight (wet) | Function |
| Mix A-1 | Polyvinyl alcohol | 110 | Binder |
| | (approximately 10% solution) | | |
| | 3-N-cyclohexyl, N-methyl | 50 | Dye |
| | amino-6-methyl-7-anilino- | | |
| | fluoran | | |
| | Foamaster P | 0.1 | Defoamer |
| | Water | 140 | |
| Mix A-2 | Polyvinyl alcohol | 100 | Binder |
| | (approximately 10% solution) | | |
| | Crystal violet lactone | 60 | Dye |
| | Foamaster P | 0.1 | |
| | Water | 160 | |
| Mix A-3 | Carboxy methyl cellulose | 110 | Binder |
| | (approximately 10% solution) | | |
| | 3 pyrrolidino-6-methyl- | 55 | Dye |
| | 7-anilino-fluoran | | |
| | Foamaster P | 0.1 | Defoamer |
| | Water | 145 | |

### Example 3

A solid composition containing a dye material for converting a latent image to a visible image was prepared as follows. Approximately 5 grams of crystal violet lactone were added to a mixture of 150 grams of di-isopropyl naphthalene and 150 grams of paraffin wax having a melting point of 125° F. The mixture was heated to 150° F. until a clear solution was formed. The mixture was then cooled and formed into an elongated shape.

### Example 4

Samples of a thermal recording material were coated at 6 g/m² with a base coating composition containing an electron-accepting compound and substantially free of any electron-donating compounds. Each sample of the recording material was contacted with a heated metal bar having a temperature of 215° F. The heated bar was applied for a duration of 5 seconds at a pressure of 3 pounds per square inch. Upon removing the heated bar, each sample appeared to be substantially free of any discoloration in the area where the heated bar was applied. Subsequently samples were contacted with both a crystal violet lactone dye and 3-isobutyl ethyl amino-6-methyl-7-anilino fluoran dye or to reveal the latent image.

### Other Embodiments

The present teachings can be embodied in other specific forms, not delineated in the above examples, without departing from the spirit or essential characteristics thereof. The present teachings can be embodied in other specific forms without departing from the spirit or essential characteristics thereof. The foregoing embodiments are therefore to be considered in all respects illustrative rather than limiting on the present teachings described herein. Scope of the present teachings is thus indicated by the appended claims rather than by the foregoing description, and all changes that come within the meaning and range of equivalency of the claims are intended to be embraced therein.

What is claimed is:

1. A thermal recording material comprising:
a substrate;
a base coating disposed on the substrate, wherein the base coating comprises an electron-accepting compound;
a first top coating disposed on a portion of the base coating, wherein the first top coating comprises a first electron-donating compound adapted to react with the electron-accepting compound in the base coating to induce a first color change; and
a second top coating disposed on a portion of the base coating, wherein the second top coating comprises a second electron-donating compound adapted to react with the electron-accepting compound in the base coating to induce a second color change;
wherein one or more portions of the base coating are exposed and adapted to record a latent image via imagewise thermal exposure.

2. The thermal recording material of claim 1, wherein the latent image is revealed by contact with an electron-donating compound.

3. The thermal recording material of claim 1, wherein the first color change is different from the second color change.

4. The thermal recording material of claim 1, wherein the electron-accepting material in the base coating is substantially colorless before and after imagewise thermal exposure.

5. The thermal recording material of claim 1, wherein before thermal exposure, the electron-accepting compound in the base coating is in crystalline form.

6. The thermal recording material of claim 5, wherein after thermal exposure, the base coating melts to form an amorphous solid comprising the electron-accepting compound.

7. The thermal recording material of claim 1, wherein the base coating further comprises a sensitizer.

8. The thermal recording material of claim 1, wherein the latent image is invisible under ambient light.

9. The thermal recording material of claim 1, wherein the electron-accepting compound in the base coating is selected from the group consisting of a phenolic compound, an aromatic carboxylic acid, a salt, and combinations thereof.

10. The thermal recording material of claim 1, wherein the base coating is substantially free of electron-donating compounds.

11. The thermal recording material of claim 1, wherein the first electron-donating compound and the second electron-donating compound are substantially colorless.

12. The thermal recording material of claim 1, wherein at least one of the first electron-donating compound and the second electron-donating compound comprises a thermal dye selected from the group consisting of a triarylmethane-based compound, a auramine-based compound, a thiazine-based compound, a spiropyran-based compound, a lactam-based compound, a fluoran-based compound, and combinations thereof.

13. The thermal recording material of claim 1, wherein each of the first top coating and the second top coating is substantially free of electron-accepting compounds.

14. A method of recording latent and multi-color visible images onto a thermal recording material, the method comprising the steps of:
(a) providing a thermal recording material of claim 1, wherein at least one exposed region of the base coating is present;
(b) heating imagewise the at least one exposed region of the base coating to produce a latent image; and
(c) heating imagewise the first top coating and the second top coating to produce visible images.

15. The method of claim 14, wherein heating imagewise the first top coating produces a visible image of one color and heating imagewise the second top coating produces a visible image of a different color.

16. The method of claim 14, wherein steps (b) and (c) are conducted in one step.

17. The method of claim 14, wherein at least one of steps (b) and (c) is performed using a direct thermal printer.

18. The method of claim 14, comprising the step of:
(d) contacting the at least one exposed region of the base coating with an electron-donating compound to reveal the latent image.

19. The method of claim 18, wherein the electron-donating compound used to reveal the latent image is selected from an infrared dye and a near infrared dye.

20. The method of claim 19, wherein the infrared dye and the near infrared dye is selected from 3,3-bis(4-diethylamino-2-ethoxyphenyl)-4-azaphthalide, 3-[2,2-bis(1-ethyl-2-methyl-3-indolyl)vinyl]-3-(4-diethylaminophenyl)phtharide, and 3,3-bis[2-(4-dimethylaminophenyl)-2-(4-methoxyphenyl)vinyl]-4,5,6,7-tetrachlorophthalide.
